(19) United States
(12) Patent Application Publication
(10) Pub. No.: US 2016/0288409 A1
(43) Pub. Date: Oct. 6, 2016

(54) Process of manufacturing sheet for membrane keyboard

(71) Applicants: Mao-Yen Wang, Changhua (TW); Chien-Ping Chen, Taoyuan City (TW)

(72) Inventors: Mao-Yen Wang, Changhua (TW); Chien-Ping Chen, Taoyuan City (TW)

(21) Appl. No.: 15/176,167

(22) Filed: Jun. 8, 2016

(51) Int. Cl. B29C 65/48; B29C 65/02; B29C 65/70; B29C 69/00; B29C 65/00

(52) U.S. Cl. CPC B29C 65/48; B29C 65/4815; B29C 69/001; B29C 69/005; B29C 66/472; B29C 65/70; B29C 65/02; B29L 2031/7676

(57) ABSTRACT

Provided is a process of manufacturing a sheet for a membrane keyboard or keypad including placing a plastic film on a thermoplastic adhesive layer; adhering a release liner to the plastic film; placing the thermoplastic adhesive layer on a lower cutting mold; adhering the release liner to an upper mold; moving hollow cutting members through both the thermoplastic adhesive layer and the plastic film to cut them into thermoplastic adhesive sections and plastic sections respectively; removing the thermoplastic adhesive sections, the plastic sections, the release liner, and the upper mold from the lower cutting mold; replacing the lower cutting mold with a lower mold having a top sheet member; placing the thermoplastic adhesive sections on the sheet member; heating to secure the thermoplastic adhesive sections, the plastic sections, and the sheet member together; removing the upper mold; and removing the release liner from the plastic sections.

### BACKGROUND OF THE INVENTION

1. Field of the Invention

The invention relates to membrane keyboards and more particularly to a process of manufacturing a sheet for a membrane keyboard or keypad.

2. Description of Related Art

A conventional notebook computer is shown in FIG. 1 and comprises a sheet B and keys A protruding therefrom. There are gaps between the key A and the sheet B. Thus, dust may fall into the keyboard to accumulate. However, this is not desired.

Thus, there is a room for improvement in the art.

### SUMMARY OF THE INVENTION

It is therefore one object of the invention to provide a process of manufacturing a sheet comprising placing a plastic film on a thermoplastic adhesive layer; adhering a release liner to the plastic film; placing the thermoplastic adhesive layer on a lower cutting mold; adhering the release liner to a bottom of an upper mold; moving a plurality of hollow cutting members of the lower cutting mold through both the thermoplastic adhesive layer and the plastic film to cut the thermoplastic adhesive layer into thermoplastic adhesive sections and cut the plastic film into plastic sections respectively; removing the thermoplastic adhesive sections, the plastic sections, the release liner, and the upper mold from the lower cutting mold; replacing the lower cutting mold with a lower mold with a sheet member placed on the lower mold; placing the thermoplastic adhesive sections on the sheet member; heating the thermoplastic adhesive sections, the plastic sections, and the sheet member to secure them together; removing the upper mold; and removing the release liner from the plastic sections to manufacture a finished sheet including the sheet member and the plastic sections.

The above and other objects, features and advantages of the invention will become apparent from the following detailed description taken with the accompanying drawings.

### BRIEF DESCRIPTION OF THE DRAWINGS

FIG. 1 is a perspective view of a conventional notebook computer;

FIG. 2 is a flow chart of a process of manufacturing the sheet according to the invention;

FIG. 3 is an exploded view of a release liner, a plastic film, and a thermoplastic adhesive layer of a sheet for a membrane keyboard or keypad according to the invention;

FIG. 4 is a schematic side elevation showing the release liner, the plastic film and the thermoplastic adhesive layer stacked on a lower cutting mold in the manufacturing process;

FIG. 5 is a view similar to FIG. 4 showing an upper mold placed on the release liner;

FIG. 6 is a view similar to FIG. 5 showing hollow cutting members inserted through the plastic film and the thermoplastic adhesive layer;

FIG. 7 is a view similar to FIG. 6 showing the upper mold, the release liner, the plastic sections and the thermoplastic adhesive sections lifted to leave wastes;

FIG. 8 is a view similar to FIG. 7 showing the lower cutting mold replaced by a lower mold and a sheet member placed on the lower mold;

FIG. 9 is a view similar to FIG. 8 showing the thermoplastic adhesive sections, the plastic sections, the release liner and the upper mold stacked on the sheet member;

FIG. 10 is a view similar to FIG. 9 showing the upper mold and the release liner lifted to leave the plastic sections, the thermoplastic adhesive sections and the sheet member on the lower mold;

FIG. 11 is a perspective view showing a removal of the release liner at the end of the manufacturing process;

FIG. 12 is schematic side elevation of the plastic sections, the thermoplastic adhesive sections and the sheet member of FIG. 11;

FIG. 13 is a perspective view showing the sheet mounted on top of a membrane keyboard of a notebook computer;

FIG. 14 is a perspective view showing the sheet to be mounted on a solar calculator; and

FIG. 15 is a perspective view showing the sheet to be mounted on a handheld transceiver.

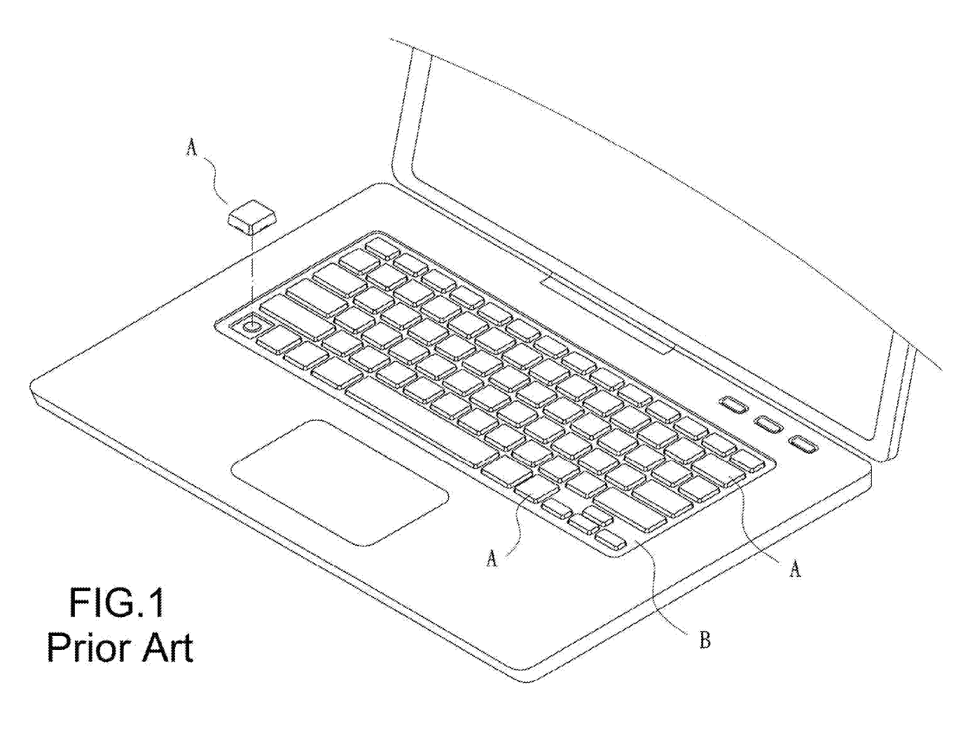

### DETAILED DESCRIPTION OF THE INVENTION

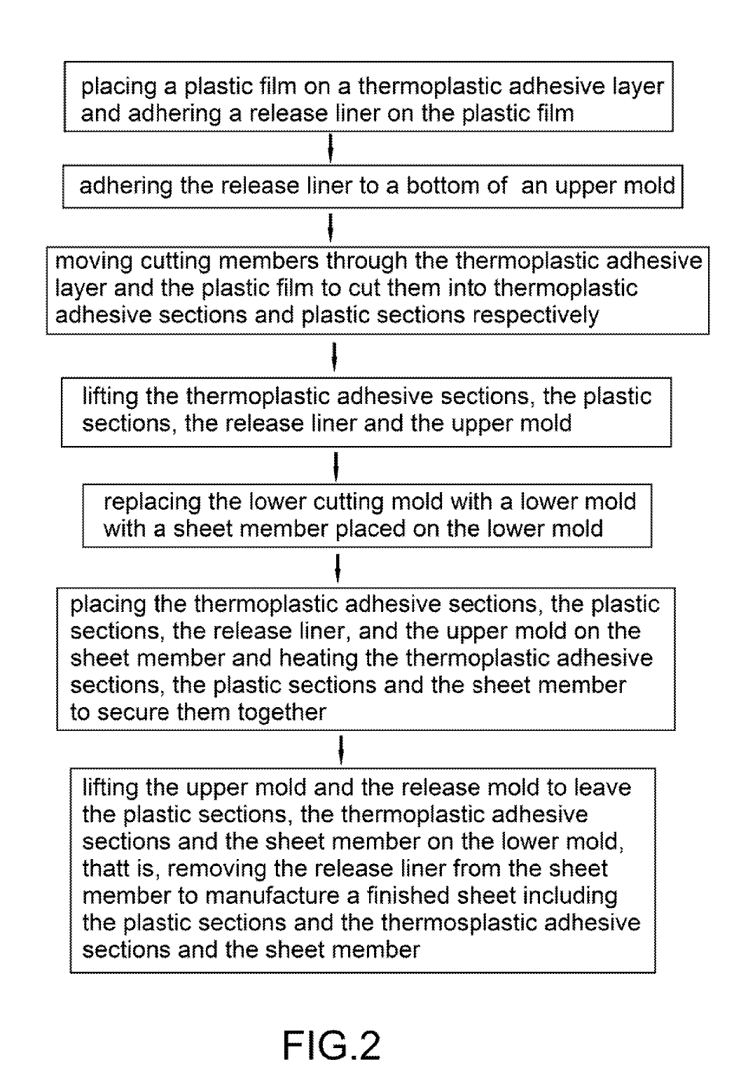

Referring to FIGS. 2 to 15, a process of manufacturing a sheet 6 for a membrane keyboard (or keypad) in accordance with the invention comprises the following steps discussed in detail below.

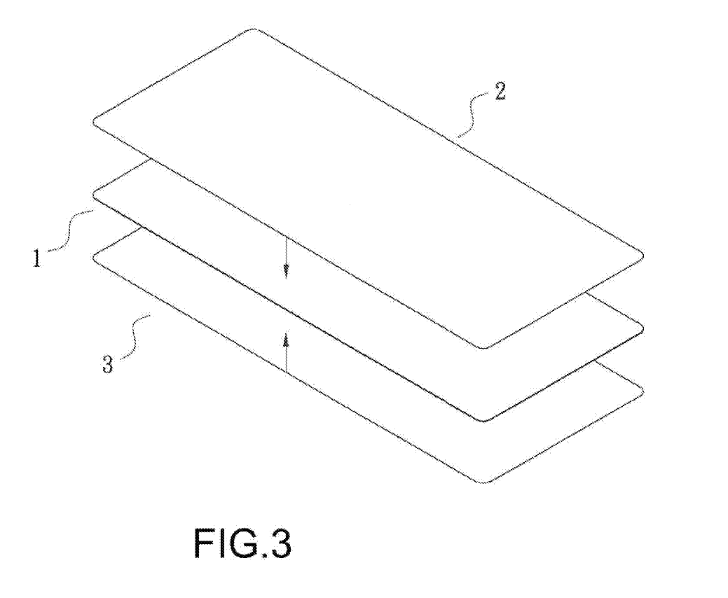

placing a plastic film 1 on a thermoplastic adhesive layer 3 and adhering a release liner 2 on the plastic film 1 (FIG. 3);

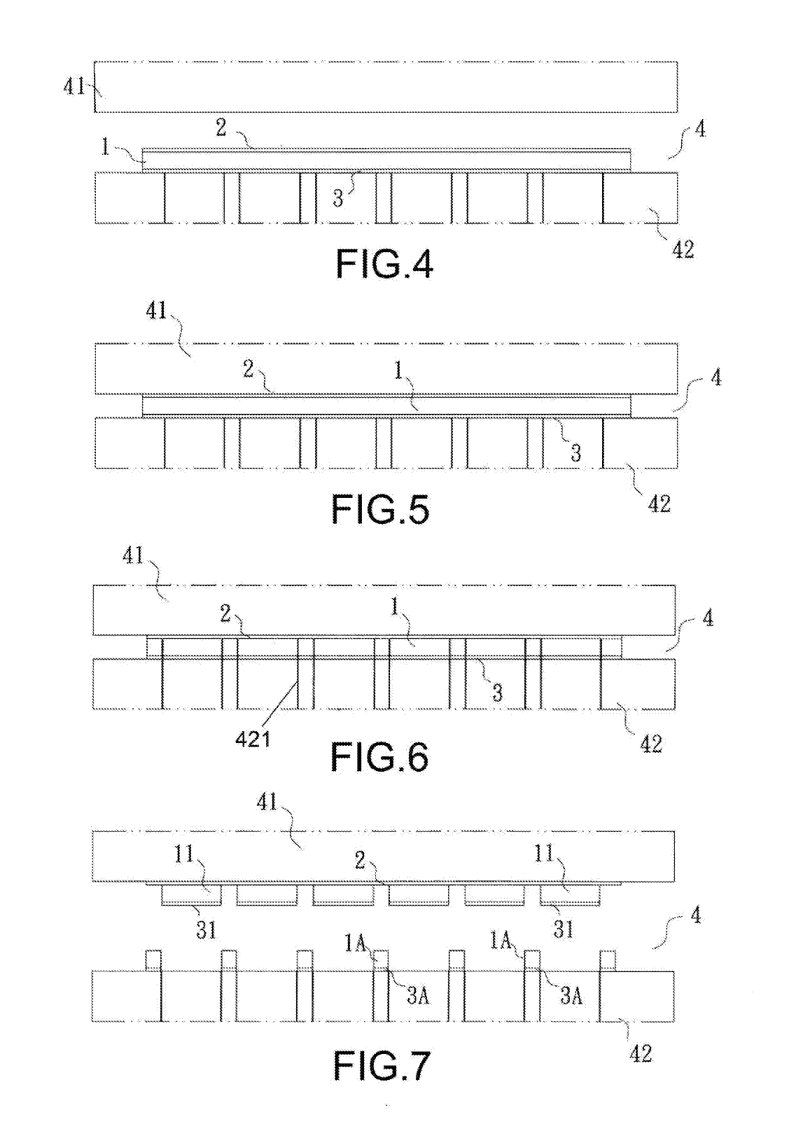

placing, from bottom to top, the thermoplastic adhesive layer 3 on a lower cutting mold 42 of a mold assembly 4 with the plastic film 1 on the thermoplastic adhesive layer 3 and the release liner 2 on the plastic film 1 (FIG. 4);

adhering the release liner 2 to a bottom of an upper mold 41 (FIG. 5);

moving a plurality of hollow cutting members 421 of the lower cutting mold 42 through both the thermoplastic adhesive layer 3 and the plastic film 1 to cut the thermoplastic adhesive layer 3 into a plurality of thermoplastic adhesive sections 31 and cut the plastic film 1 into a plurality of plastic sections 11 respectively (FIG. 6);

lifting the thermoplastic adhesive sections 31, the plastic sections 11, the release liner 2 and the upper mold 41 to leave waste 3A of the thermoplastic adhesive sections 31 on the mouths of the hollow cutting members 421 and waste 1A of the plastic sections 11 on the thermoplastic adhesive sections 31 respectively (FIG. 7);

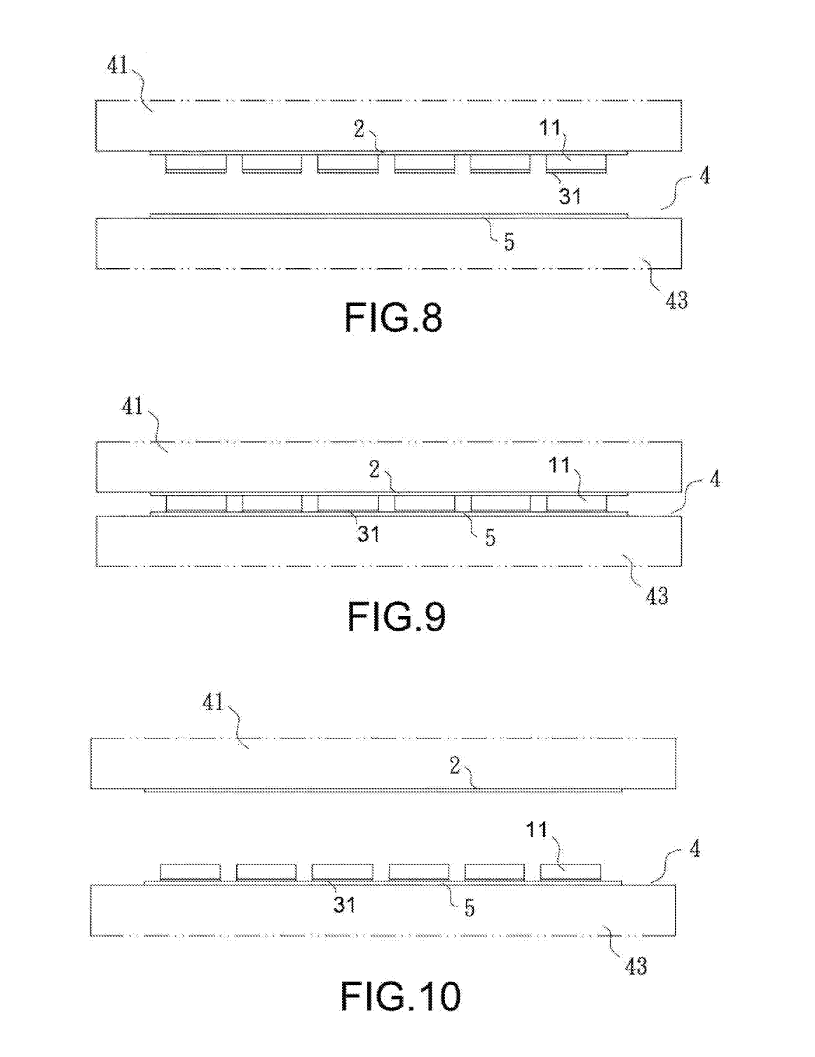

replacing the lower cutting mold 42 with a lower mold 43 with a sheet member 5 placed on the lower mold 43 (FIG. 8);

placing, from bottom to top, the thermoplastic adhesive sections 31, the plastic sections 11, the release liner 2, and the upper mold 41 on the sheet member 5 and heating the thermoplastic adhesive sections 31, the plastic sections 11, and the sheet member 5 to secure them together (FIG. 9);

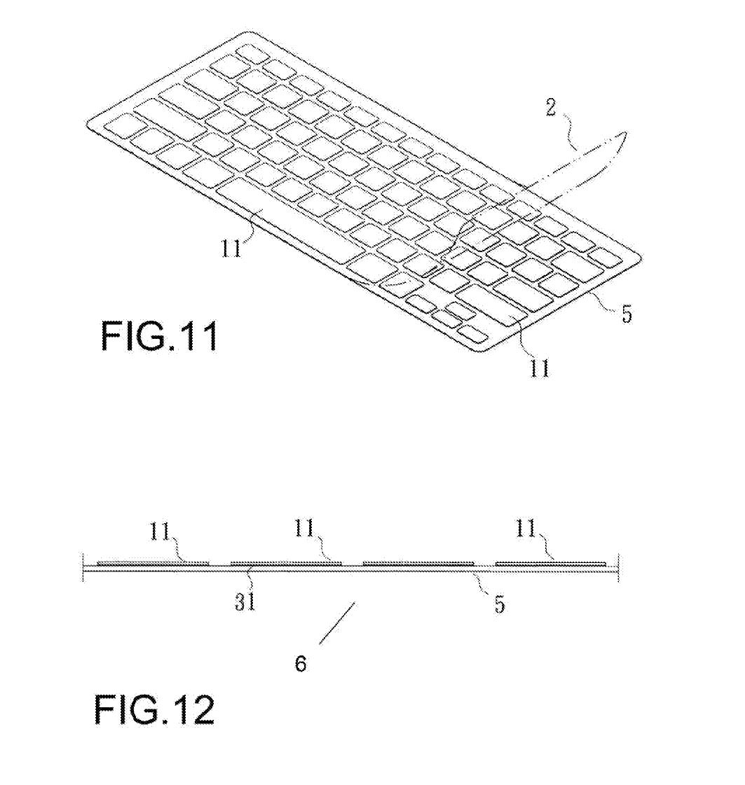

lifting the upper mold 41 and the release liner 2 to leave the plastic sections 11, the thermoplastic adhesive sections 31, and the sheet member 5 on the lower mold 43 (FIG. 10), that is, removing the release liner 2 out of the sheet member 5 to manufacture a finished sheet 6 including the plastic sections 11, the thermoplastic adhesive sections 31, and the sheet member 5 at the end of the manufacturing process (FIGS. 11 and 12).

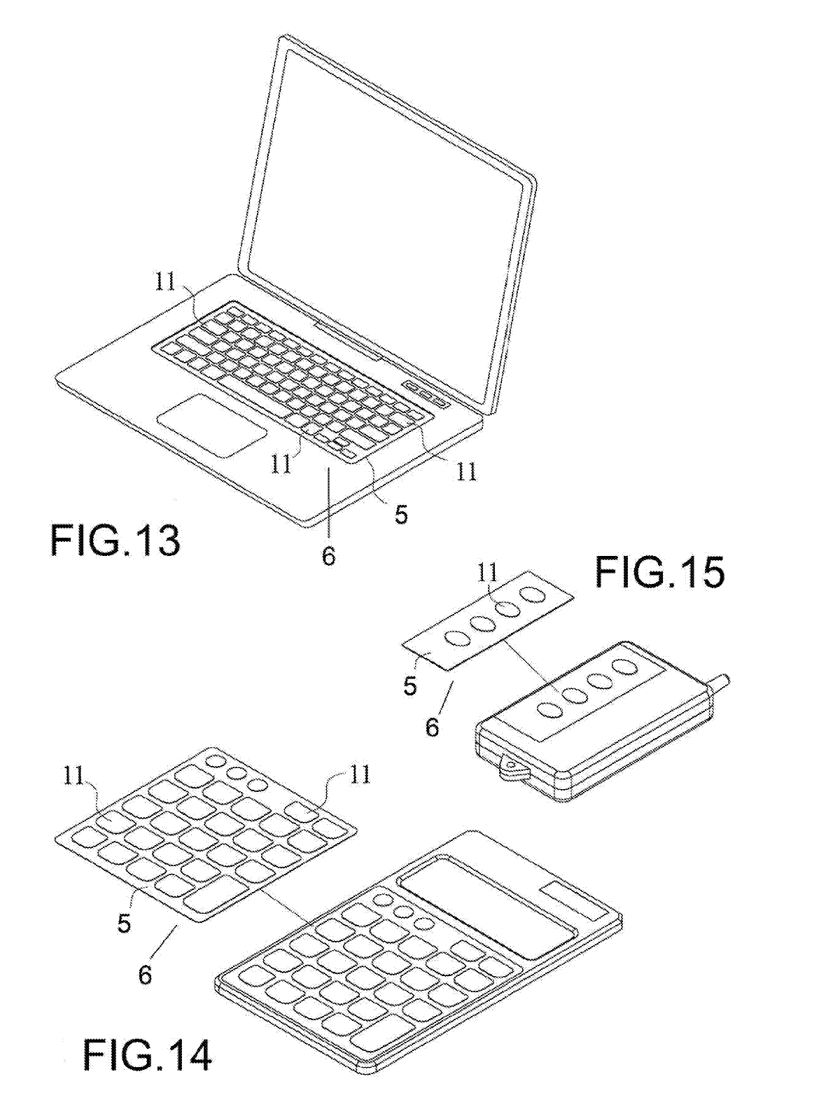

A shown in FIGS. 13 to 15, the sheet 6 is mounted on top of a membrane keyboard of a notebook computer, the sheet 6 is to be mounted on a solar calculator, and the sheet 6 is to be mounted on a handheld transceiver respectively.

It is envisaged by the invention that there are no gaps between a key and the plastic section 11.

While the invention has been described in terms of preferred embodiments, those skilled in the art will recognize that the invention can be practiced with modifications within the spirit and scope of the appended claims.

What is claimed is:

1. A process of manufacturing a sheet comprising the steps of:
placing a plastic film on a thermoplastic adhesive layer;
adhering a release liner to the plastic film;
placing the thermoplastic adhesive layer on a lower cutting mold;
adhering the release liner to a bottom of an upper mold;
moving a plurality of hollow cutting members of the lower cutting mold through both the thermoplastic adhesive layer and the plastic film to cut the thermoplastic adhesive layer into a plurality of thermoplastic adhesive sections and cut the plastic film into a plurality of plastic sections respectively;
removing the thermoplastic adhesive sections, the plastic sections, the release liner, and the upper mold from the lower cutting mold;
replacing the lower cutting mold with a lower mold with a sheet member placed on the lower mold;
placing the thermoplastic adhesive sections on the sheet member;
heating the thermoplastic adhesive sections, the plastic sections, and the sheet member to secure them together;
removing the upper mold; and
removing the release liner from the plastic sections to manufacture a finished sheet including the sheet member and the plastic sections.
